(19) United States
(12) Patent Application Publication
(10) Pub. No.: US 2014/0255562 A1
(43) Pub. Date: Sep. 11, 2014

(54) EXTRUSION-TYPE FROZEN DESSERT STORAGE CONTAINER FOR PREVENTING UNDESIRED AND FORCED EXTRUSION

(71) Applicant: Chuan-Tai Chien, New Taipei City (TW)

(72) Inventor: Chuan-Tai Chien, New Taipei City (TW)

(21) Appl. No.: 13/789,131

(22) Filed: Mar. 7, 2013

(51) Int. Cl. A23G 9/28

(52) U.S. Cl. CPC A23G 9/28
USPC 426/115

(57) ABSTRACT

An extrusion-type frozen dessert storage container for preventing undesired and forced extrusion of a frozen dessert contained therein, including a container body and a sealing membrane. The container body includes an upper container body, a connection portion and a lower container body which are connected with each other. The upper chamfer cambered surface of the upper container body has at least one convex body. The bottom surface of lower container body is provided with an extrusion opening and the inner wall of the container body defines a storage space communicated with the extrusion opening. The sealing membrane adheres to the bottom surface of the container body and is covered on the extrusion opening.

### BACKGROUND

1. Field of Invention

The present invention relates to a storage container. More particularly, the present invention relates to a frozen dessert storage container that prevents undesired and forced extrusion of the frozen dessert contained therein.

2. Description of Related Art

An ice cream container structure is disclosed in Taiwan Patent No. M272776. The ice cream container structure shapes the ice cream extruded out from it by an ice cream machine. If it is desired to change the cut shape of extruded ice cream, it is necessary to disassemble some components of the ice cream machine, which is very inconvenient.

A storage barrel container structure used for a soft ice cream machine is disclosed in Taiwan Patent No. M241390. Although it is possible to use the components of the storage barrel container structure itself to control the shape of the ice cream extruded therefrom, there is a large number of such components involved, and moreover, the components have a complex structure and offer poor design flexibility. Additionally, after some of the ice cream has been extruded from the storage barrel container structure, the volume of the storage barrel container structure cannot be reduced in an effective manner, resulting in an unnecessary use of a large space.

### SUMMARY

The present invention provides an extrusion-type frozen dessert storage container that has a simple structure, allows for use of its own components to change the shape of the frozen dessert extruded therefrom, is able to be reduced in volume after the frozen dessert has been extruded therefrom, and prevents undesired and forced extrusion of the frozen dessert contained therein.

An aspect of the present invention provides an extrusion-type frozen dessert storage container for preventing undesired and forced extrusion of a frozen dessert contained therein, including a container body and a sealing membrane. The container body includes an upper container body, a connection portion and a lower container body which are connected with each other. The outer diameter of the upper container body is smaller than the inner diameter of the lower container body. The upper container body has an upper circular container wall, an upper chamfer cambered surface and a top surface which are connected with each other. The upper chamfer cambered surface has at least one convex body. The lower container body has a lower circular container wall, a lower chamfer cambered surface and a bottom surface. The bottom surface is provided with an extrusion opening. The inner wall of the container body defines a storage space communicated with the extrusion opening. The sealing membrane adheres to the bottom surface and is covered on the extrusion opening.

According to an embodiment of the present invention, the sealing membrane has a membrane main body and a pressure-type opening unit. The pressure-type opening unit is at the central part of the membrane main body and is covered on the extrusion opening.

According to an embodiment of the present invention, the pressure-type opening unit has several sector sheets arranged circularly, and each of the sector sheets has an arc edge and two side edges connected with each other. The arc edge of each sector sheets is connected to the membrane main body through a connection portion and an arc edge dotted line, and the two side edges of each sector sheet are respectively connected to the side edges of adjacent sector sheets through side edge dotted lines.

According to an embodiment of the present invention, the top surface of the upper container body is provided with a convex lifting sheet.

### BRIEF DESCRIPTION OF THE DRAWINGS

In order to make the foregoing as well as other aspects, features, advantages, and embodiments of the present invention more apparent, the accompanying drawings are described as follows:

FIG. 1 is a perspective view of an extrusion-type frozen dessert storage container that prevents undesired and forced extrusion of the frozen dessert contained therein according to an embodiment of the present invention;

FIG. 2 is an exploded perspective view of the extrusion-type frozen dessert storage container of FIG. 1;

FIG. 3 is a schematic cross-sectional view of the extrusion-type frozen dessert storage container of FIG. 1;

FIG. 4 is a schematic view of the extrusion-type frozen dessert storage container of FIG. 1, illustrating the extrusion-type frozen dessert storage container in a state placed correctly in a container slot of an extrusion machine;

FIG. 5 is a schematic cross-sectional view of the extrusion-type frozen dessert storage container of FIG. 1 after the frozen dessert contained therein has been extruded from the extrusion-type frozen storage container;

FIG. 6 is a schematic view of the extrusion-type frozen dessert storage container of FIG. 1, illustrating the extrusion-type frozen dessert storage container in a state placed incorrectly in a container slot of an extrusion machine; and

FIG. 7 is a schematic view of the extrusion-type frozen dessert storage container of FIG. 1, illustrating how an extrusion operation may be performed smoothly even when a sealing membrane has not been first removed.

### DETAILED DESCRIPTION

The foregoing and other technical contents, features and functions of the present invention will be presented hereafter in the detailed description of embodiments with reference to the accompanying drawings.

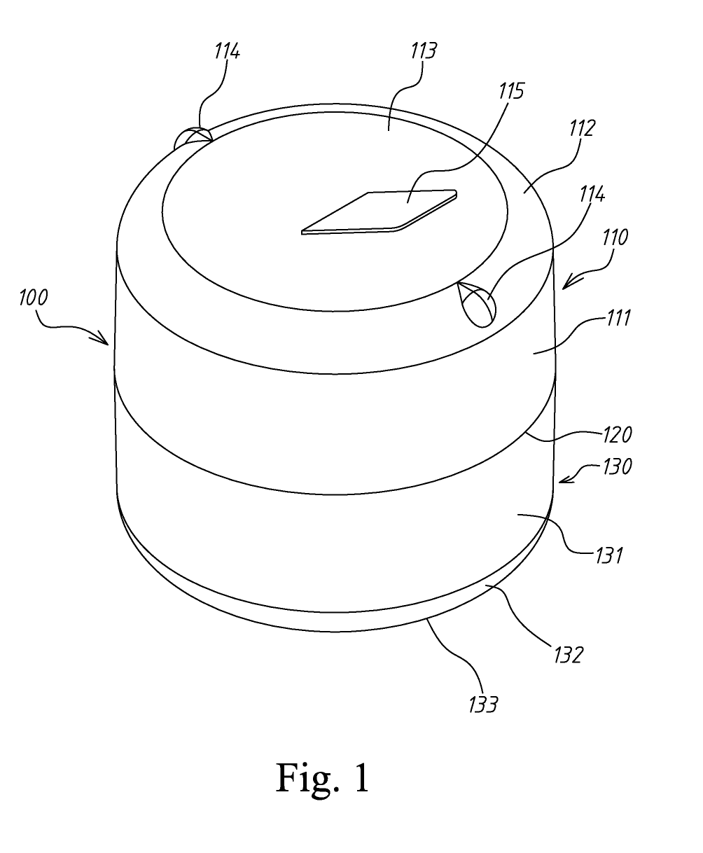

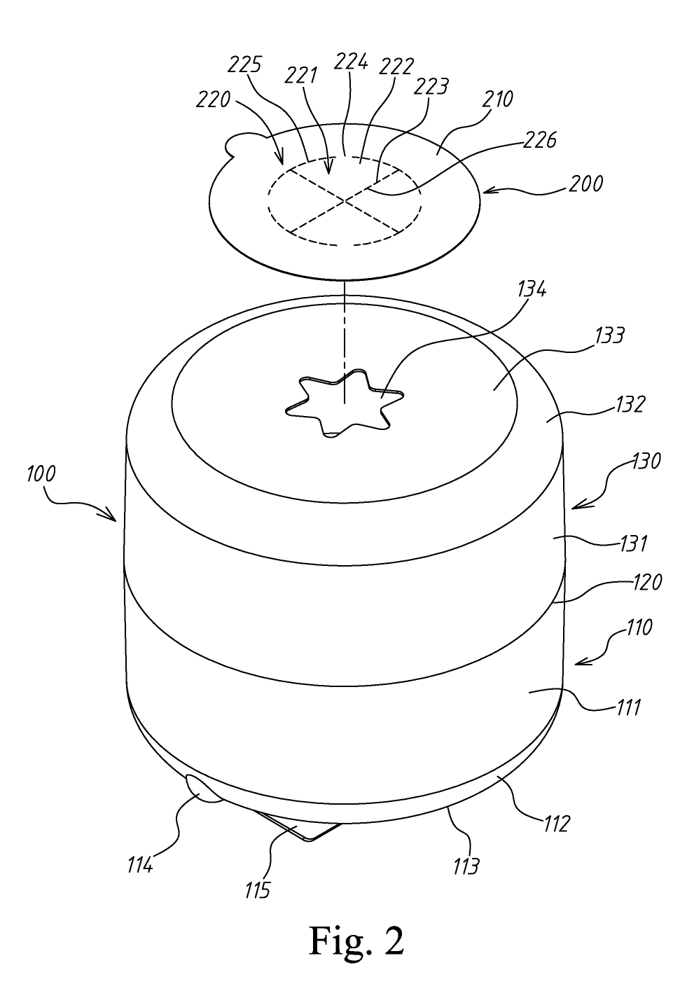

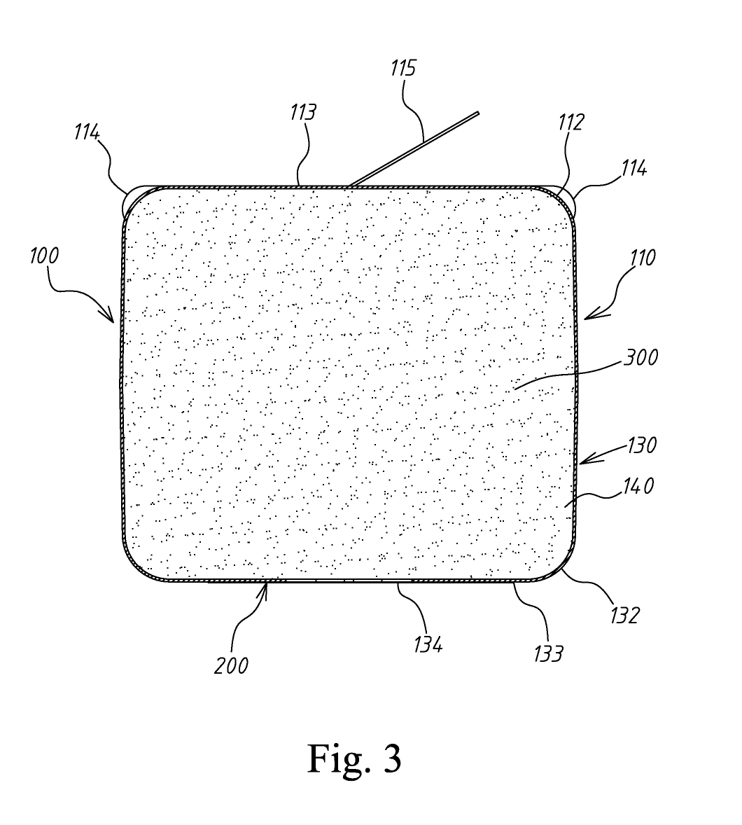

As shown in FIGS. 1-3, an extrusion-type frozen dessert storage container that prevents undesired and forced extrusion of the frozen dessert contained therein according to an embodiment of the present invention includes a container body 100 and a sealing membrane 200.

The container body 100 is shaped by blowing air into plastic materials to form a hollow body. The container body 100 includes an upper container body 110, a connection portion 120 and a lower container body 130 which are connected with each other. The outer diameter of the upper container body 110 is smaller than the inner diameter of the lower container body 130. The upper container body 110 has an upper circular container wall 111, an upper chamfer cambered surface 112 and a top surface 113. The upper chamfer cambered surface 112 is provided with a convex body 114 at each of two opposite positions thereon, to alter the user to the fact that the container body 100 has been placed upside prior to an extrusion operation (to be explained hereinafter). The lower container body 130 is similar to the upper container body 110 in structure, having a lower circular container wall 131, a lower chamfer cambered surface 132 and a bottom surface 133 which are connected with each other. The bottom surface 133 is provided with an extrusion opening 134. The inner wall of the container body 100 defines a storage space 140 communicated with the extrusion opening 134.

The storage space 140 is used to store a frozen dessert 300, such as ice cream. The extrusion opening 134 may be of any geometric shape (e.g., star-shaped, heart-shaped, rectangular or circular), so as to enhance the aesthetics and uniqueness of the extruded frozen dessert 300. In this embodiment, the extrusion opening 134 is star-shaped, as an example.

The sealing membrane 200 is made of a plastic film and is adhered to the bottom surface 133 of the lower container body 130. The sealing membrane 200 has a membrane main body 210 and a pressure-type opening unit 220. The pressure-type opening unit 220 is at the central part of the membrane main body 210 and is covered on the extrusion opening 134.

The pressure-type opening unit 220 has several sector sheets 221 arranged circularly, and each of the sector sheets 221 has an arc edge 222 and two side edges 223. The arc edge 222 of each sector sheet 221 is connected to the membrane main body 210 through a connection portion 224 and an arc edge dotted line 225, and the two side edges 223 of each sector sheet 221 are connected to the side edges 223 of adjacent sector sheets 221 respectively through side edge dotted lines 226. When the container body 100 is not subjected to an extrusion pressure, the pressure-type opening unit 220 formed by the connection of the sector sheets 221 is covered on the extrusion opening 134, so as to prevent the frozen dessert 300 stored in the storage space 140 of the container body 100 from flowing out from the extrusion opening 134. However, when the frozen dessert 300 in the container body 100 is being extruded, the arc edge dotted lines 225 and the side edge dotted lines 226 are broken due to the extrusion pressure, changing the pressure-type opening unit 220 to an open state.

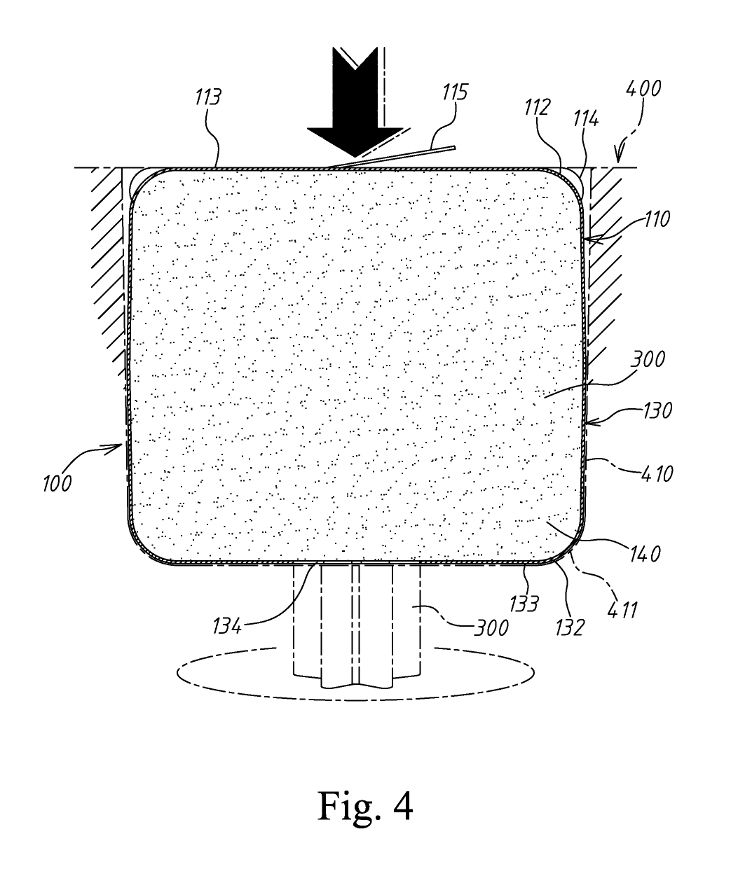

Referring additionally to FIG. 4, when it is intended to extrude the frozen dessert 300 from the container body 100, the sealing membrane 200 is removed from the bottom surface 133 of the container body 100, so as to expose the extrusion opening 134, and the container body 100 is placed in a container slot 410 of an extrusion machine 400 with the lower container body 130 placed downwards (that is, with the bottom surface 133 and the extrusion opening 134 of the lower container body 130 facing downwards). The container slot 410 is provided with a port (not shown) corresponding to the position of the extrusion opening 134 at the bottom thereof. The lower chamfer cambered surface 132 of the lower container body 130 is engaged with a chamfer cambered surface 411 at the bottom of the container slot 410, such that the container body 100 is snugly accommodated in the container slot 410. Subsequently, an extrusion rod (not shown) of the extrusion machine 400 is displaced in a direction from the top surface 113 of the container body 100 to the extrusion opening 134 at the bottom surface 133, and as a result, the frozen dessert 300 is shaped and extruded from the extrusion opening 134. Thus, the extruded frozen dessert 300 is formed into a special shape.

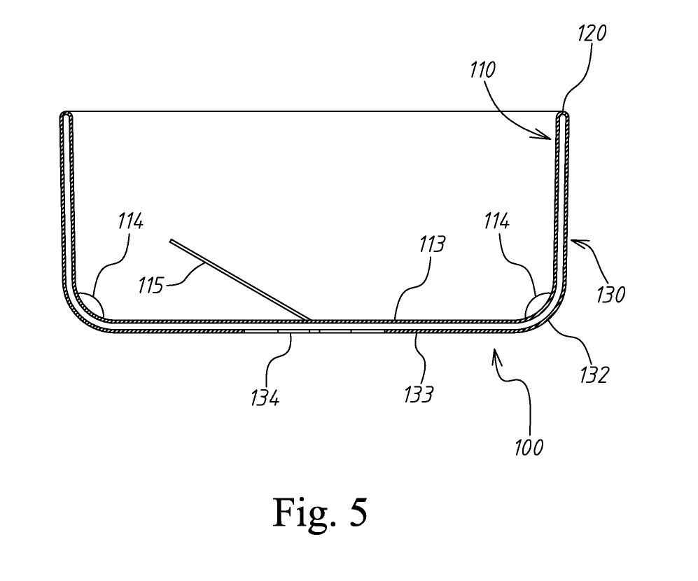

Referring particularly to FIG. 5, when the frozen dessert 300 is fully extruded from the container body 100, the connection portion 120 is folded and the upper container body 110 of the container body 100 is pressed into the interior of the lower container body 130, thereby reducing the volume of the container body 100 significantly after the frozen dessert 300 is extruded therefrom.

The top surface 113 of the upper container body 110 is further provided with a convex lifting sheet 115, which may be used as a handle after the frozen dessert storage container has been compressed by the extrusion machine 400, so the empty and deformed frozen dessert storage container can be conveniently removed from the container slot 410 of the extrusion machine 400.

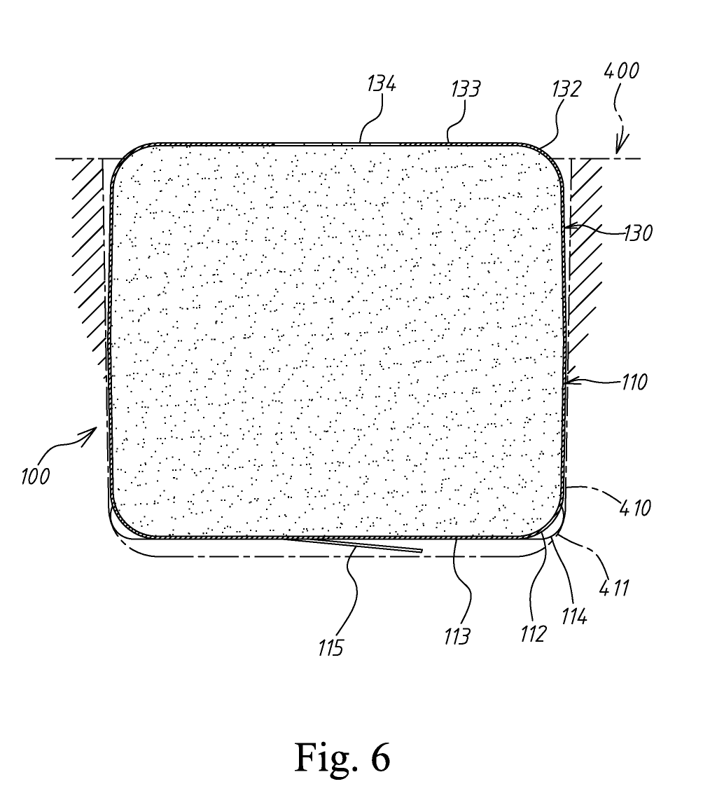

Referring to FIG. 6, during the extrusion operation described above, if a user incorrectly places the container body 100 in the container slot 410 of the extrusion machine 400, i.e., the user places the container body 100 in the container slot 410 of the extrusion machine 400 with the upper container body 110 facing downwards such that the top surface 113 of the upper container body 110 faces downwards and the extrusion opening 134 of the lower container body 130 faces upwards, the convex bodies 114 positioned at the upper chamfer cambered surface 112 of the upper container body 110 cannot conform with the configuration of the chamfer cambered surface 411 at the bottom of the container slot 410, so that the container body 100 is forced upward above the container slot 410 and the extrusion rod of the extrusion machine 400 cannot be turned. With such a configuration, the frozen dessert 300 is prevented from being extruded from the extrusion opening 134 and thereby spoiling the interior of the extrusion machine 400.

When the extrusion rod of the extrusion machine 400 cannot be turned as described above, the user can be alerted to the fact that the container body 100 is placed upside down and it is necessary to correct the placement direction thereof. Therefore, the convex bodies 114 of the present invention can prevent the extrusion of the frozen dessert 300 when the container body 100 is placed upside down.

With respect to a correct extrusion operation, the sealing membrane 200 ideally should be removed before extruding the frozen dessert 300 from the container body 100, so as to expose the extrusion opening 134. However, some users may neglect to remove the sealing membrane 200 before placing the container body 100 into the container slot 400 of the extrusion machine 400. Without the particular configuration of the sealing membrane 200 described above, this would otherwise result in the frozen dessert 300 not being extruded out smoothly under the extrusion force of the extrusion machine 400, and instead, being extruded forcefully only after the extrusion force of the extrusion machine 400 increases to a level that is larger than the adhering force of the sealing membrane 200, at which time the sealing membrane 200 would burst suddenly. If such a scenario would occur, a large amount of the frozen dessert 300 stored in the container body 100 would suddenly rush out, resulting in an unattractive shape of the frozen dessert 300, and in extreme instances, even spilling of the frozen dessert 300 onto the ground.

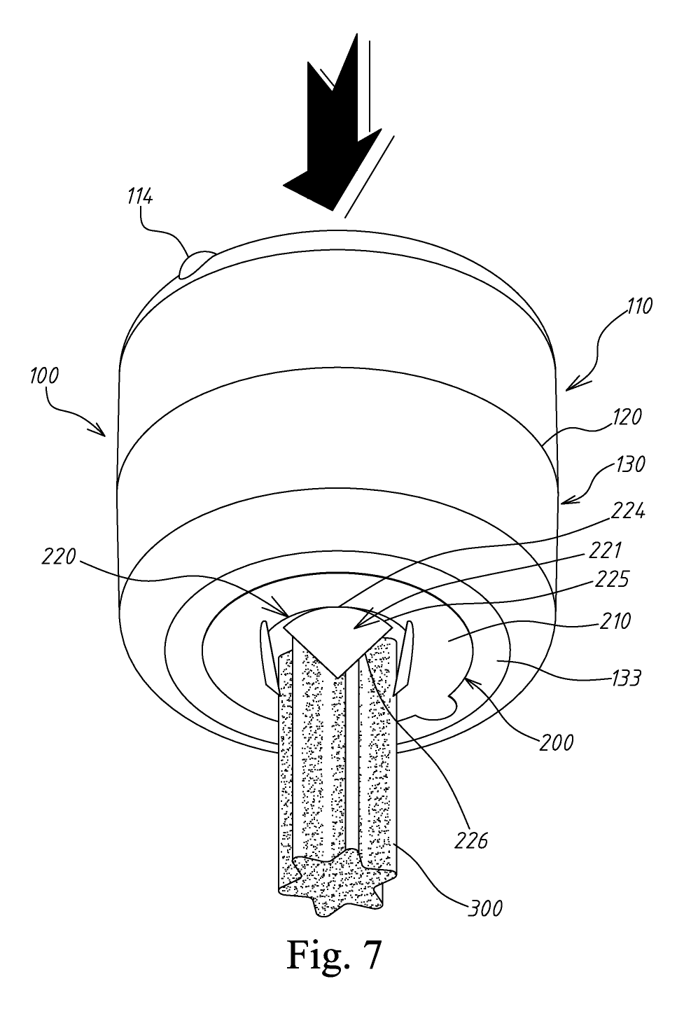

The sealing membrane 200 of the present invention can prevent such an occurrence. This will be described with reference to FIG. 7, in which it is assumed that prior to an extrusion operation of the frozen dessert 300 from the container body 100, the user has placed the container body 100 into the container slot 410 of the extrusion machine 400 without first removing the sealing membrane 200. In this case, since the sealing membrane 200 is able to withstand only a small amount of pressure due to the arc edge dotted lines 225 and the side edge dotted lines 226 arranged on the sector sheets 221 of the pressure-type opening unit 220, during the extrusion operation, the initial extrusion force applied to the container body 100 and the frozen dessert 300 stored therein by the extrusion machine 400 breaks the arc edge dotted lines 225 and side edge dotted lines 226, forcing the sector sheets 221 to an outwardly open state utilizing the connections 224 as pivoting axes thereof, so as to expose the extrusion opening 134 of the container body 100. Hence, the frozen dessert 300 stored in the container body 100 can be extruded under the extrusion force of the extrusion machine, preventing such sudden extrusion as described above.

In view of the above, the extrusion-type frozen dessert storage container that prevents undesired and forced extrusion of the frozen dessert contained therein according to an embodiment of the present invention, in addition to having a simple structure and a structure that allows a reduction in the volume of container body after extrusion, can also prevent problems associated with operator errors, such as placing the container body upside down and neglecting to remove the sealing membrane.

Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

1. An extrusion-type frozen dessert storage container for preventing undesired and forced extrusion of a frozen dessert contained therein, comprising:
a container body comprising an upper container body, a foldable connection portion and a lower container body which are connected with each other, wherein the outer diameter of the upper container body is smaller than the inner diameter of the lower container body to allow the upper container body to be pressed into the lower container body after the frozen dessert is extruded from the container body; the upper container body has an upper circular container wall, an upper chamfer cambered surface and a top surface which are connected with each other; the upper chamfer cambered surface has at least one convex body protruding outwardly to prevent the extrusion of the frozen dessert when the container body is placed upside down; the lower container body has a lower circular container wall, a lower chamfer cambered surface and a bottom surface which are connected with each other; the bottom surface is provided with an extrusion opening and the inner wall of the container body defines a storage space communicated with the extrusion opening; and
a sealing membrane which adheres to the bottom surface and is covered on the extrusion opening.

2. The extrusion-type frozen dessert storage container of claim 1, wherein the sealing membrane has a membrane main body and a pressure-type opening unit, and the pressure-type opening unit is at the central part of the membrane main body and is covered on the extrusion opening.

3. The extrusion-type frozen dessert storage container of claim 2, wherein the pressure-type opening unit has several sector sheets arranged circularly, and each of the sector sheets has an arc edge and two side edges, wherein the arc edge of each sector sheet is connected to the membrane main body through a connection portion and an arc edge weakened line, and the two side edges of each sector sheet are connected to the side edges of adjacent sector sheets respectively through side edge weakened lines.

4. The extrusion-type frozen dessert storage container of claim 1, wherein the top surface of the upper container body is provided with a convex lifting sheet.
